(19) United States
(12) Patent Application Publication
(10) Pub. No.: US 2022/0319344 A1
(43) Pub. Date: Oct. 6, 2022

(54) Method of Learning Based on 21st Century Technology

(71) Applicant: Jordan Louis Marchino, Lower Gwynedd, PA (US)

(72) Inventor: Jordan Louis Marchino, Lower Gwynedd, PA (US)

(21) Appl. No.: 17/221,768

(22) Filed: Apr. 2, 2021

(51) Int. Cl. G09B 5/00; G09B 19/00; G06Q 50/20

(52) U.S. Cl. CPC G09B 5/00; G09B 19/00; G06Q 50/205

(57) ABSTRACT

A learning method (the 21st Method) that includes 7 Learning Structures that are married to touch of a button access to information/data (Internet or some facsimile thereof), which comprise the embodiment(s) of the patent depicted in flowchart and written form. This learning method has only now become possible with our ability to pull data at the touch of a button via computer/internet technology; this learning method should also be thought of as a training process that bolsters cognitive skills—including focus, logic and creativity. This learning method stands namely in contrast to our conventional system of reading books in a linear fashion from page 1 to page 2 to page 3 and so on, from chapter 1 to chapter 2 to chapter 3 and so on, and then utilizing repetition as a means of clarifying that which is unclear during said linear process—this is essentially the totality of the learning system that we are all exposed to en masse from a very early age. The 21st Method works in a manner that is very similar to the methodology used by computer languages in the fact that a computer program is using PROGRAMMING STRUCTURES (i.e. Loops/If Then Statements/Case Structures/etc.), where the 21st Method is using LEARNING STRUCTURES. We can think of the 21st Method as always working with raw data (through the use of its Learning Structures) in the same way that the computer is always working with raw data (through the use of its Programming Structures). The 21st Method uses either a reverse engineer or non-linear technique in approaching the study material (textbook, PDF, etc.). This approach throws the user into the material without any context, and then the Learning Structures are applied to said material as a means of making clear any and all information. This is possible due to the mathematically perfect logic that the Learning Structures bring to any and all material—that is, universal laws that can be applied in all cases to any material. This is only now made workable with the ability to pull any and all information/data at the touch of a button.

### DESCRIPTION OF DRAWINGS

FIG. 1: Flowchart Permutation 1 Regarding Final 3 Processes at the Bottom Right Corner of Flowchart.

FIG. 2: Flowchart Permutation 2 Regarding Final 3 Processes at the Bottom Right Corner of Flowchart.

FIG. 3: Flowchart Permutation 3 Regarding Final 3 Processes at the Bottom Right Corner of Flowchart.

FIG. 4: Flowchart Permutation 4 Regarding Final 3 Processes at the Bottom Right Corner of Flowchart.

FIG. 5: Flowchart Permutation 5 Regarding Final 3 Processes at the Bottom Right Corner of Flowchart.

FIG. 6: Flowchart Permutation 6 Regarding Final 3 Processes at the Bottom Right Corner of Flowchart.

These permutations are variable due to the prerogative of the user at the particular time of use, based on the variability of the material that is being studied as well as based on the variability of the individual. This embodiment with the 6 permutations has been preferred with regard to the placement of structures such as the A, E and R LEARNING STRUCTURES as it relates to the more prominent C1-C3, FSS and PE1-PE3 LEARNING STRUCTURES.

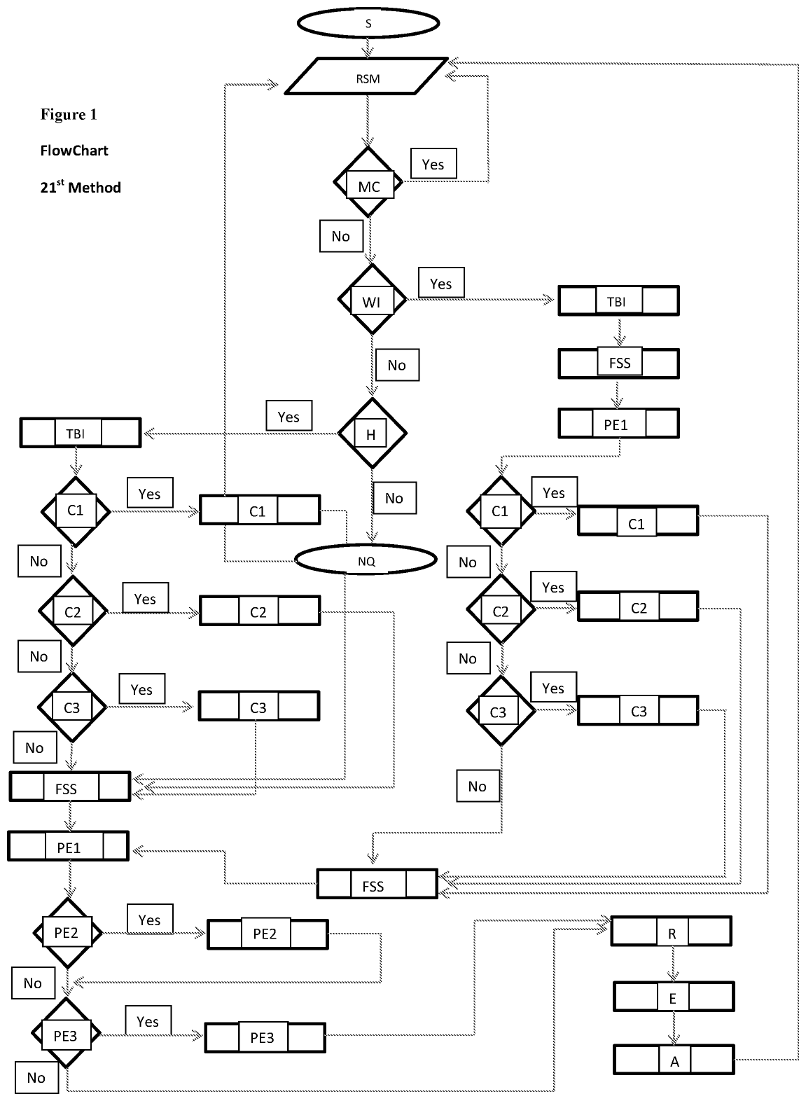

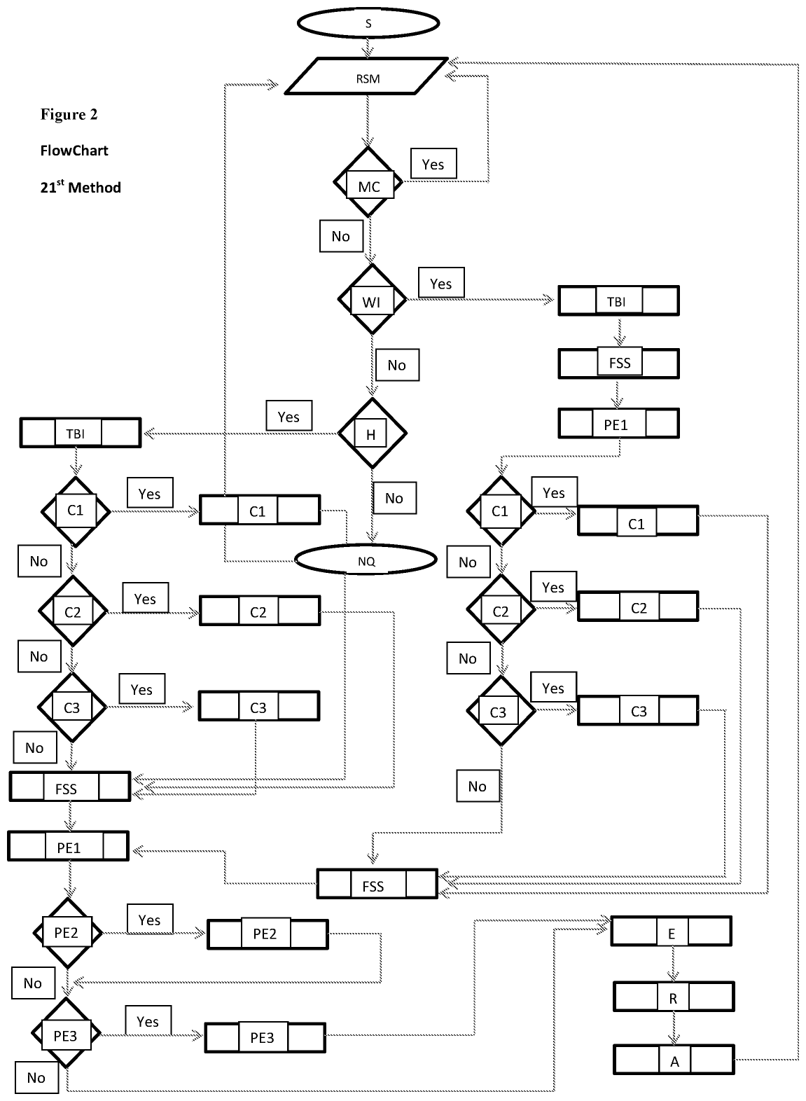

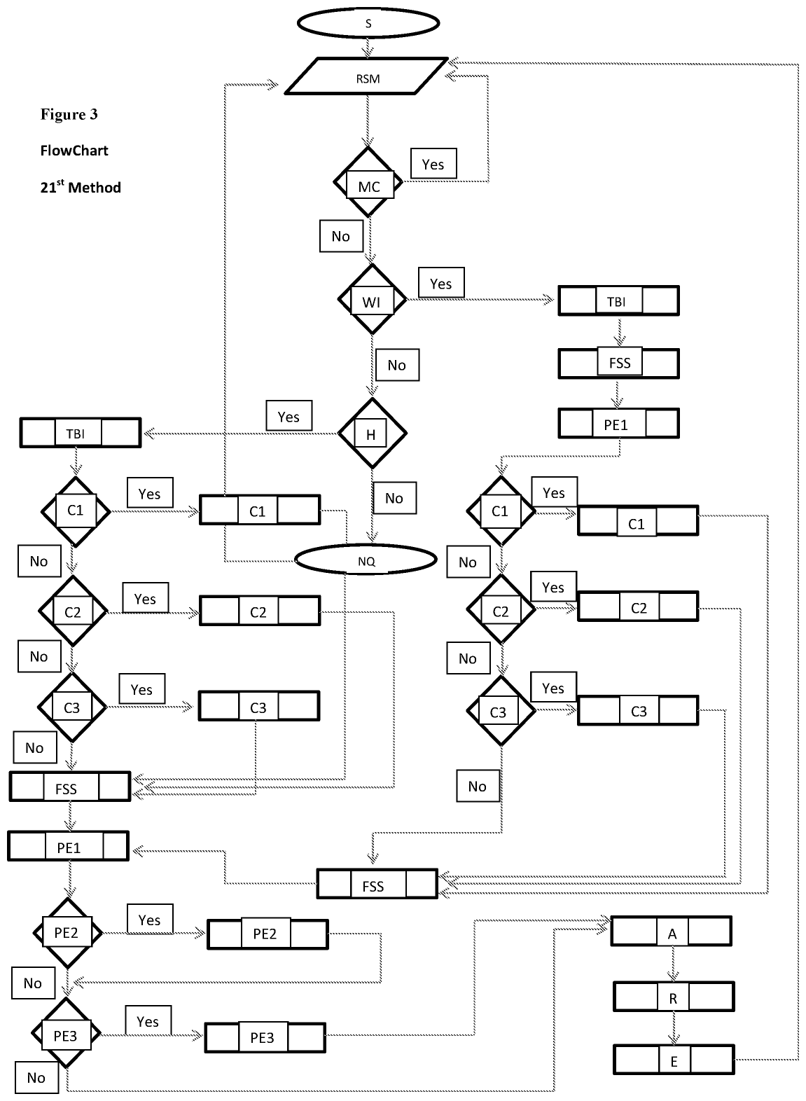

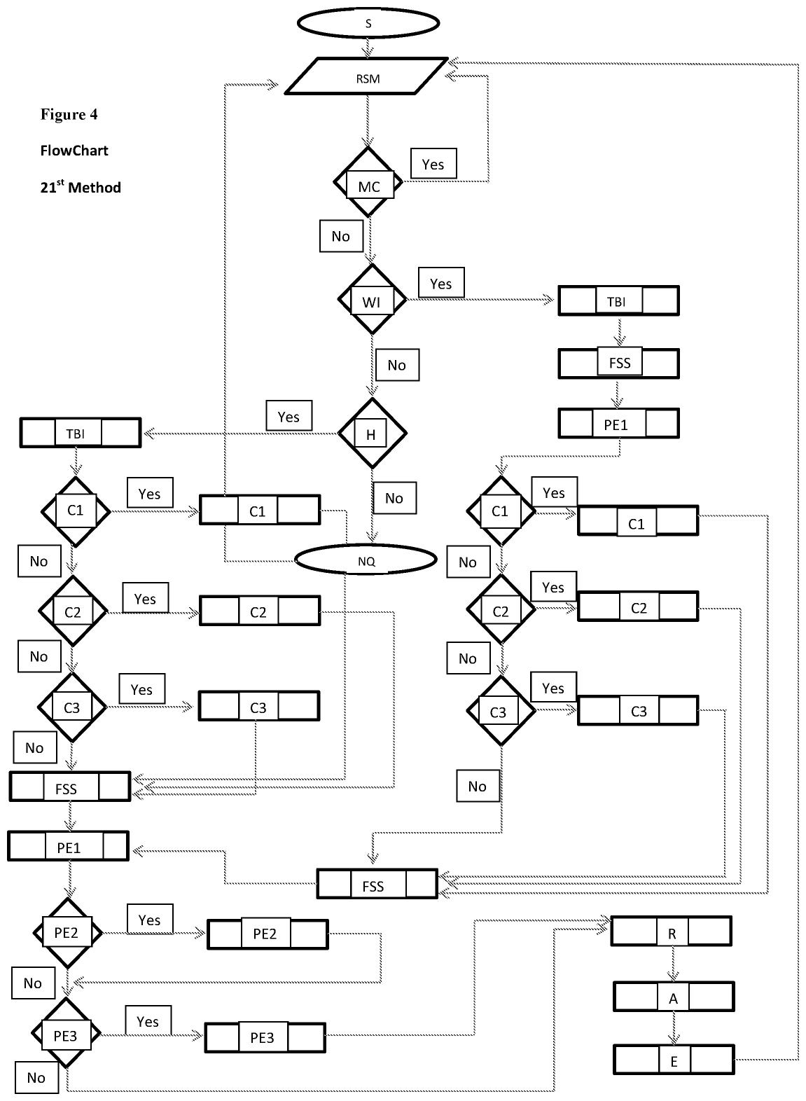

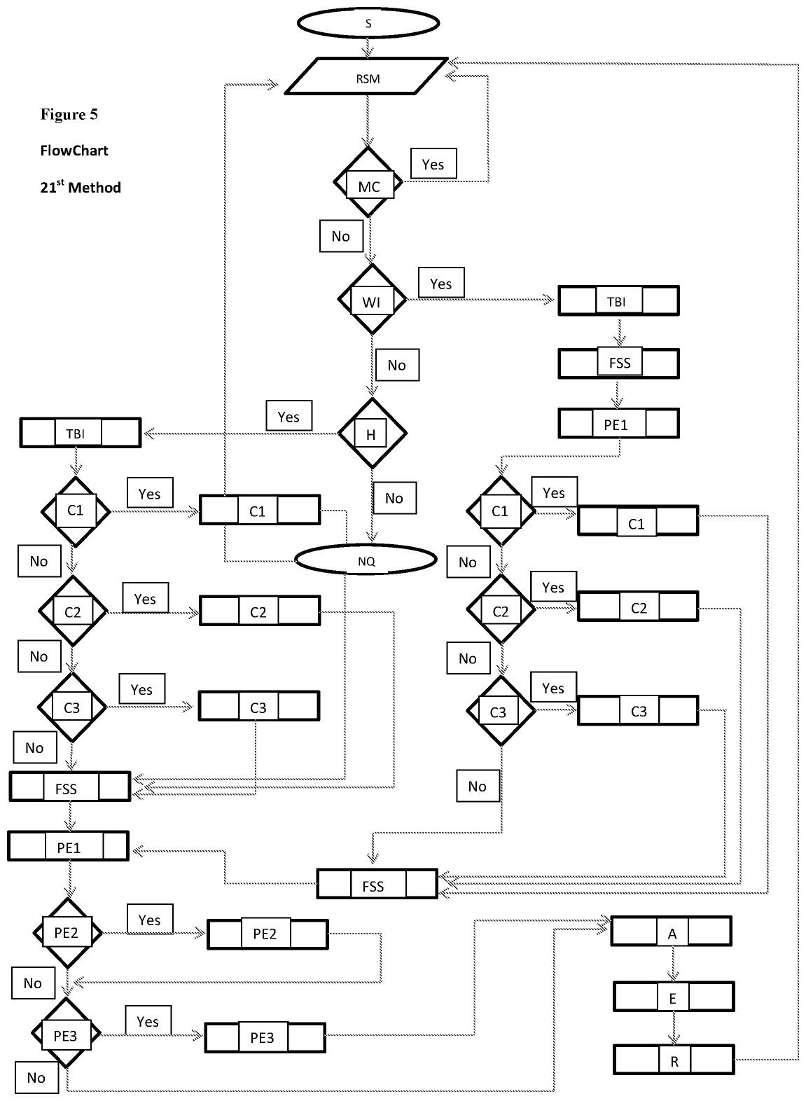

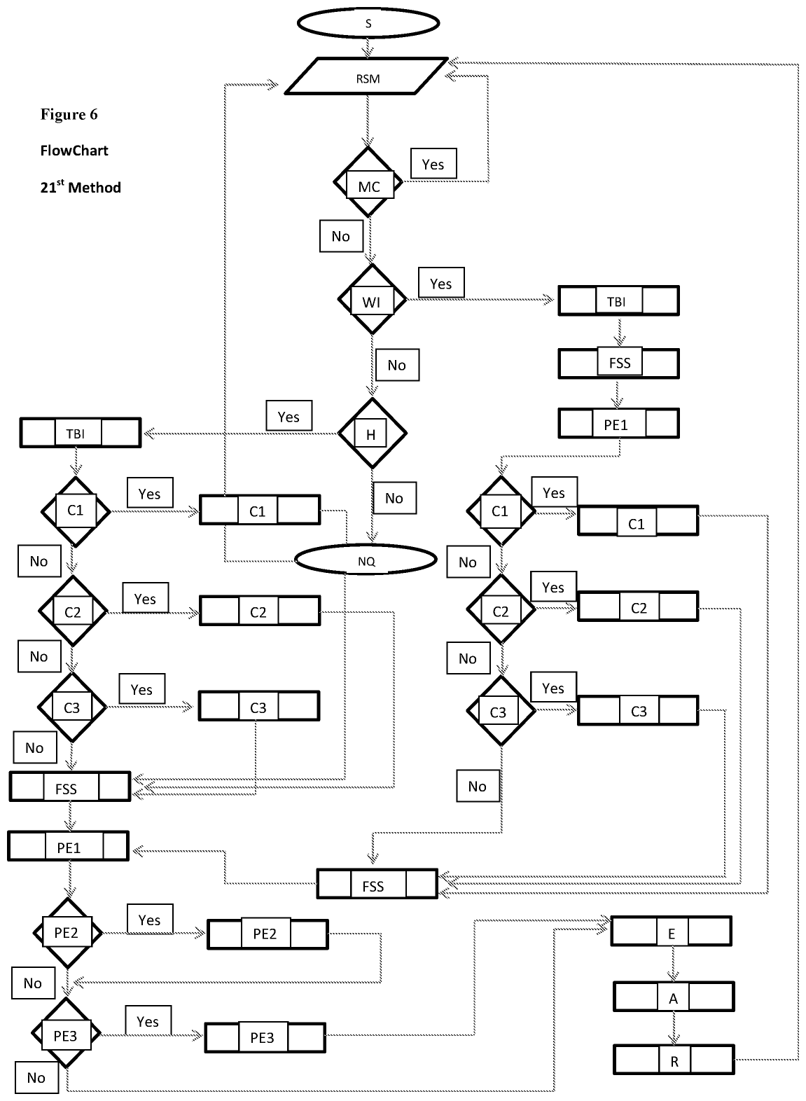

### KEY FOR FIGS. 1-6 FOR FLOWCHART SHAPES

Rectangle Shape in Flowchart Represents a Process to be Executed.
Diamond Shape in Flowchart Represents a Decision to be Made.
Rhomboid Shape in Flowchart Represents the Input of Data (Source Study Material).
Oval Shape in Flowchart Represents the Start or End of Process/Sub-Process.

FIG. 1-6 Key for Flowchart Letters
Start: S
Read Source Material: RSM
Source Material That Was Read Was Comprehended: MC
Touch of a Button Access to Information: TBI
The Question “What Is?” Occurs During Reading of Source Material: WI
The Question “How?” Occurs During Reading of Source Material: H
The Reader Has No Questions: NQ
Contrast Structure 1: C1
Contrast Structure 2: C2
Contrast Structure 3: C3
Flowing System Structure: FSS
Process of Elimination Structure 1: PE1
Process of Elimination Structure 2: PE2
Process of Elimination Structure 3: PE3
Attenuation Structure: A
Never Waste Brain Energy Structure: E
Repetition Structure: R
Not Included in Flowchart
Reverse Engineer Structure: (RES)
Non-Linear Structure: (NLS)

Using RES/NLS would be decided on before starting the embodiment depicted as flowchart—and the flowchart would remain exactly the same as it is in FIGS. 1-6, regardless of whether using RES or NLS.

### BACKGROUND

Once the Internet evolved to a certain level of capacity and speed, a new era of learning was made possible. The ability to pull any and all information/data by simply touching keys, “touch of a button access to information/data”, was birthed into the world. The 21st Method is not possible in a world of physical textbooks that require large sums of time just to locate information, let alone properly consume (the information). This new era in technology gives us touch of a button access to information/data, and this is what sets the stage for the 21st Method; the 21st Method is not possible without this ability. The conventional learning system as it stands is a one-size-fits-all system of linear reading and answering questions, moving from section to section, as each section builds from the previous section—and in the case that the student has a problem with comprehension, they are simply given one LEARNING STRUCTURE: Repetition. They are told to read it again, do the exercises again and so forth. I refer to this conventional system as having two LEARNING STRUCTURES: LINEAR LEARNING STRUCTURE and the REPETITION STRUCTURE. This is the background that we all share in education. Had touch of a button access to data/information been available when the educational system was crafted, then clearly the educational system would look very different than it does today. The 21th Method was not only made possible by this new ability to pull data at the touch of a button, but also by studying the logic of computer systems and how they work with raw data for the purpose of maximizing speed and efficiency. In this way, the 21th Method also shares a common bond with the DECISION STRUCTURES (or PROGRAMMING STRUCTURES) used by computer programs to act on data, e.g. If, Then Statements/Loops/Case Structures/etc. Just as these computer programming structures set the table for the functionality of computer systems, the LEARNING STRUCTURES of the 21th Method in conjunction with touch of a button access to information/data set the table for this advanced system of learning for all learners.

### SUMMARY

There is a method by which, when trained into the mind, can vastly increase focus and intelligence over time—this is the 21th Method. It is so simple to apply that it is almost impossible to believe, and that is one of the reasons that it works—it had to be simple in its presentation and application. There is a template that can be superimposed over any information, which will in turn elucidate said information. We can think of the 21st Method as one big template that fits over any and all information/data. This is primarily made possible due to the fact that there is a common denominator running through all things (FLOWING SYSTEM STRUCTURE).

The 21st Method solves numerous problems in education. There are many students who have great intelligence, but they simply do not jibe well with the conventional approach to education. And now, with touch of a button access to information/data made available—they have the opportunity to use the 21st Method as an alternative option for learning. I liken the problems that we are facing in this regard as to a freshly built new computer that has all the top of the line components installed, except just one component that was taken from a very old computer (RAM for example). This computer with all of these new state of the art components will only work as fast as the old RAM inside (the RAM would not be compatible—but this is to draw a metaphor). We have been changing dramatically as a society due to technological advancements, while leaving other aspects of society alone and unchanged for a century. The idea that only now this one alternative method in education is coming to the forefront, I think, will leave people in disbelief. When we can now have a student who is strugging, and have the ability to say ok, “here is a completely different way of learning, try this and see if it works for you.” And when we see it working for people, the disbelief will be in the fact that all of this time went by, and only just now can we offer even one workable alternative in learning for students.

### DETAILED DESCRIPTION

The CONTRAST STRUCTURE is one of the seven total LEARNING STRUCTURES contained within the 21^{st} Method. It is important to note, the term CONTRAST STRUCTURE is used to incorporate both the contrast and the compare functions of the mind—the CONTRAST STRUCTURE looks at both differences and similarities, not just differences when being applied within the 21^{st} Method. Contrast is one of the main learning constructs within the human mind that goes beyond what a computer can truly reproduce—it is partially responsible for the invention of the computer to begin with. And as we can clearly see, computers have not been able to reproduce this ability of ours to spontaneously create completely new technologies from scratch. Within the 21^{st} Method, the CONTRAST STRUCTURE utilizes three forms, denoted as C1, C2 and C3, and they are denoted as such within FIGS. 1-6 of the 21^{st} Method Flowchart in the diagrams section. For the 21^{st} Method, we want to keep in mind just how powerful an agent the CONTRAST STRUCTURE is. Using contrast properly can get specific areas of the brain related to learning and creativity optimally stimulated, so we seek to use contrast as much as we possibly can during our application of the 21^{st} Method. While using the 21^{st} Method, C1 refers to contrast that is immediately located within the vicinity of our study material, i.e. the text makes a direct reference to Cardinals and Blue Jays for example within the same paragraph that we are currently reading, so we proceed to carry out the CONTRAST STRUCTURE between these two distinct birds. As will be explained to some extent more, there are two sides to writing this patent—one side is the very basic side that gives stark instructions with regard to carrying out the method, and the other side is the deeper side of the patent that requires some training over time to fully grasp. With that said, for the time when it is stated to apply the CONTRAST STRUCTURE—this should be understood as simply taking in this case a Cardinal, and simply transforming the narrative form of what the reference book explains a Cardinal to be, and turning this into a list of bullet point characteristics/components that define every aspect of the Cardinal—and doing the same for the Blue Jay. Analysis is then conducted from the standpoint of comparing two (or more) similar but different kinds of entities/items/etc. to gain the deepest comprehension possible, which is further made clear when we move these characteristic/component data points into the FLOWING SYSTEM STRUCTURE to be processed and further understood through this LEARNING STRUCTURE as well. If we had no idea what a Cardinal was, and we used TBI to investigate a Cardinal, that would lead us one way. But, if we instead used our contrast/compare CONTRAST STRUCTURE to take everything that is a Cardinal on one side and everything that is a Blue Jay on the other side, then by doing this correctly, we will not only end up with a better understanding of what Cardinals and Blue Jays are, but we will have a deeper understanding of birds in general by doing this. This is why we are constantly trying to apply either C1, C2 or C3 to our learning process—it puts us on the path to the deepest possible understanding, as well as stimulates our own creative thoughts more effectively (which also has its own value with regard to the 21^{st} Method). All of this has now become possible to apply in our learning thanks to TBI.

All of this serves a purpose that will not necessarily be self-evident right away, and this is the deeper training side of the invention that was previously mentioned. For the second form of contrast, C2, this is an extrapolated form of contrast. For example we read a sentence that mentions ark proteins, we can then extrapolate that if there are “ark” proteins then more than likely there must be other kinds of proteins as well, so we would use TBI (touch of a button access to information) to find our examples of proteins and proceed to use the CONTRAST STRUCTURE between our ark proteins and other relevant proteins that we have located. The third contrast (C3) has to do with using what we already know and understand, to contrast against that which we are trying to understand—this C3 form of the CONTRAST STRUCTURE would not be used as commonly as C1 and C2. A broad example of C3 would be something like having a background in electronics while learning about genetics. We would undoubtedly see connections between the two as we learn, and we would use C3 to contrast specific areas of genetics with electronics as a means to further elucidate the study material, and to form the deepest possible comprehension. In fact, even though C3 will be less commonly used throughout the 21^{st} Method—it is ultimately one of the most important aspects used to gain complete mastery over the 21^{st} Method (seeing the connections that run through all things). Making all of these kinds of connections and simplifying all things (ATTENUATION STRUCTURE) serves the purpose of allowing for enormous amounts of information to be consumed in the shortest time possible. This and other goals that increase learning and thinking aptitude are engrained into the 21^{st} Method.

Contrast is a very important learning structure. Contrast will be used below to elucidate the 21^{st} Method by contrasting it with both the conventional learning system and with the methods employed by computers to read and process data. We will look at our current conventional learning system as a reference. The current learning system trains us to use two LEARNING STRUCTURES, and we are all more than familiar with these two learning structures. The first LEARNING STRUCTURE is the LINEAR LEARNING STRUCTURE (please give attention to terms for the sake of contrast). The LINEAR LEARNING STRUCTURE is what tells us to open our textbooks to page 1, and continue on moving front to back, page by page, reading and doing exercises, answering questions, and then moving to subsequent sections and chapters as the material builds from what was covered in previous sections and chapters—that is the LINEAR LEARNING STRUCTURE. We have one other structure that is drilled into our minds to complement the LINEAR LEARNING STRUCTURE, and that is the REPETITION STRUCTURE. That is to say, if during our process of moving along with the LINEAR LEARNING STRUCTURE we come across something that is unclear, we are told to read it again, do the exercises again, answer the questions again and so forth. Those are the two LEARNING STRUCTURES that comprise our narrative-based, slow-moving learning system.

The Method of Learning Based On 21st Century Technology utilizes seven LEARNING STRUCTURES in conjunction with TBI, in contrast to the two that we just mentioned used by the conventional system. It should stand to reason that more learning structures would be used when we are essentially taking the narrative out of the learning and utilizing either a non-linear or reverse engineer approach to learning (REVERSE ENGINEER/NON-LINEAR LEARNING STRUCTURE), which is chiefly interested in data points rather than reading a narrative. To be clear, and this is also mentioned later, when we talk about applying the 21^{st} Method, we are talking about applying it to any learning material—whether that be a standard textbook or a pdf file on the computer, etc. In reference to what is stated in the method as “non-linear”, this is a reference to the fact that we would not be confined to studying from a sequence of chapters while using the 21^{st} Method; we can move through the material in any order of our choosing, i.e. First chapter 6, then chapter 3, then chapter 9, etc. The 21^{st} Method is taking something similar to the architecture for learning and processing information used by computers, and combining this with the human structures of learning and processing, in conjunction with TBI, which then allows us to perfect our own minds in efficiency and efficacy with regard to all things related to learning, focusing and thinking—as well as maximizing our creative abilities. There are multiple reasons that this increases our creative abilities, one of them is simply due to the fact that there is so much brain energy left over once we process using the 21^{st} Method, that we are not bogged down in narratives that restrain our creativity. While that may seem redundant with regard to this patent, it does have some relevance due to the fact that this bolstered creativity also increases our learning and thinking abilities with relation to the 21^{st} Method as well.

The LEARNING STRUCTURES of the 21^{st} Method in conjunction with touch of a button access to information/data (TBI) will allow the user to systematically de-construct anything—as the student reads what he/she does not understand, the LEARNING STRUCTURES of the 21^{st} Method guide the reader to comprehension by using universal principles in logic. There are different kinds of LEARNING STRUCTURES in the 21^{st} Method. There are LEARNING STRUCTURES that guide the process, LEARNING STRUCTURES that build logical frameworks to aid in comprehension, LEARNING STRUCTURES that initiate parts of the brain used to maximize and optimize our learning capabilities and LEARNING STRUCTURES that refine the overall learning process itself—some LEARNING STRUCTURES serve more than just one of these purposes.

The Method of Learning Based on 21st Century Technology, as was mentioned, uses seven LEARNING STRUCTURES. There is an order of importance to these structures. The two most important of the LEARNING STRUCTURES are the FLOWING SYSTEM STRUCTURE and the CONTRAST STRUCTURE. As was mentioned, it is through contrast that we are able to initiate access to some of the most important aspects of our brain that set us apart from the electronics computer, and that will always mark us as superior in nature to the electronics computer (as long as the computer is predicated on binary digits and transistors). Contrast allows us to activate our creative nature and it also plays a major role in our higher learning functions. The FLOWING SYSTEM STRUCTURE is the LEARNING STRUCTURE that demands that the student train their minds to understand that everything that exists, can be depicted as a flowing system (logical frameworks). This is not only helpful in training the mind to accept the logic that exists in all things, but it is very important in the fact that it sets the context in study material in all cases—never will a student feel lost due to a lack of context when their brain has been trained to understand the fact that *everything* is a flowing system. If only half of things, or 90% of things, or even 99% of things were flowing systems, then this LEARNING STRUCTURE would not have the impact that it has in the 21^{st} Method. This one LEARNING STRUCTURE does so much—it presents all things in life as a template that must be labeled (SYSTEM), and then arrows (FLOW) added to indicate what is exactly flowing (blood, electricity, water, etc.) and in what given direction it flows. It is when we begin to apply the concept of flowing systems within flowing systems that we begin to see how comprehension is actually forced into the mind. We can think of it as a ladder with many rungs. If we think about the flowing systems that we are dealing with somewhere in the middle of the ladder, then we can think of going down the ladder as moving down toward atoms and quantum particles, or as we move up the ladder (if our object of study was a human body for example), we could think of whole organs as flowing systems (size)—this layered approach ensures that the process is comprehensive, and when paired with PE1 (examined below), it ensures that it is both comprehensive and without any gaps. The major point here is, the LEARNING STRUCTURES force the questions that move the reader to the answers, again, based on universal logic that never fails. It is also very important to understand that this also applies to the flow side of the FLOWING SYSTEM STRUCTURE. In other words, as we look at the above example of rungs taking us up and down to understand the system at both higher and lower levels—this also works just the same in the understanding of the flow (what is flowing) side as well. The reader identifies a heart and asks the question, “what is a heart”, it is a flowing system because all things are flowing systems, so label the components (SYSTEM) and the flow (blood is flowing in this case of course). Now, when the reader labels the components (by applying the FLOWING SYSTEM STRUCTURE), they ask themselves for example, “what is a ventricle?” (heart), again, everything is a flowing system so a heart ventricle is a flowing system as well and it has its own parts (or components) as well, and it has its role in the FLOW of blood. Slowly, as this process continues, all things are revealed in terms of how the flow is being handled in the heart by addressing all components as flowing systems themselves and the components of the components as flowing systems and so forth, and which components do what exactly with relation to blood flow and so on. This very simple line of questioning logic (FLOWING SYSTEM STRUCTURE) eventually leads to comprehension at every possible level—as long as the TBI itself is complete and accurate.

It is important to remember that the brilliance in many cases exists in simplicity. As an example of this, let's look at another one of the LEARNING STRUCTURES in the 21^{st} Method, and this is the one LEARNING STRUCTURE that is shared between the 21^{st} Method and the conventional system: the REPETITION STRUCTURE. Do we not see the brilliance in simplicity of the REPETITION STRUCTURE. Even a small child can be told to repeat the same procedure over and over, and in doing this, their memory, understanding and skill all grow at once with relation to the procedure that they are repeating, which also coincides with changes in brain tissue. What could be more simple, and yet so effective. And with relation to the 21^{st} Method, the REPETITION STRUCTURE is used when necessary, when the user deems it necessary with relation to the study material at hand and the other LEARNING STRUCTURES. The 21^{st} Method creates a synergy in using these seven LEARNING STRUCTURES and a flow, a constant flow of learning that moves from one LEARNING STRUCTURE to the next. I like to say that the LEARNING STRUCTURES are constantly running into one another, with one LEARNING STRUCTURE handing off to the next. With that said, we would say that the REPETITION STRUCTURE is something like a supporting structure, just as it is in the conventional learning system. The notion of a “constant flow” has connections with the NEVER WASTE BRAIN ENERGY STRUCTURE, which is one of the more simplistic LEARNING STRUCTURES, but it contributes instructions that are vital to the architecture, flow, speed and efficiency of the 21^{st} Method.

The next LEARNING STRUCTURE in the 21^{st} Method is the PROCESS OF ELIMINATION STRUCTURE. This LEARNING STRUCTURE serves as both a primary and supporting structure. There are three forms of process of elimination used in the 21^{st} Method, denoted as PE1, PE2 and PE3, and they are denoted as such within FIGS. 1-6 of the 21^{st} Method Flowchart in the diagrams section of the patent.

PE1 is primarily used in conjunction with the FLOWING SYSTEM STRUCTURE to ensure that no components (SYSTEM) of the system of the flowing system have been missed—i.e. eliminating the possibility that a component or components of the system were left out when applying the FLOWING SYSTEM STRUCTURE. PE1 is in essence always ensuring that the information is complete. This structure would also be eliminating the possibility that anything with regard to flow had been missed. It is a process of eliminating that any gap or content is missing by fully utilizing TBI in conjunction with the FLOWING SYSTEM STRUCTURE. All learning information inevitably must go through the FSS, which results in the application of PE1 on all material, which results in the elimination of the possibility that any gaps are left in any of the material. We are depicting everything as a flowing system, so it is simply a matter of constantly checking off that all parts, at every level of the flowing system, have been included and properly analyzed, as well as everything related to flow (PE1).

PE2 is one of those applications within the method that for many people will have to be taught over time, and will not instantly be 100% clear in many cases. The most simplistic example that explains how PE2 works is in the case that you have a fairly large binary number that you have to read and translate to decimal, let's say it is 16 binary digits long. If the number looks like this 1000000000000001, we know that we are only concerned with the binary digits that are ON (1). Having that mentality, the first thing we can do is eliminate a gigantic portion of what it is that we are looking at, and we are left with simply two l's. We of course run the exponent math on the placement of each 1 and then we add them to receive 32,769, in this case. This approach is what is referred to as PE2 within the 21^{st} Method. This approach has great significance when we are constantly seeking out information to fill into our models of logic using the 21^{st} Method—it allows us to quickly seek and attain the data that we need without wasting time, and this again, takes some time to train. We would of course be doing this with text (not binary numbers) in most cases, so it is a matter of applying that same notion of eliminating mass portions of data, so that we are left with only the data that is currently pertinent to our objective. It is a matter of constantly looking at our bulk material with an eye to eliminating (and segmenting) as much as possible in favor of the material that is of immediate interest.

The third usage of the PROCESS OF ELIMINATION STRUCTURE (PE3) is about identifying consistencies so that you are eliminating repeating elements. For example if you walked into an industrial park that manufactured cars (without having ever seen one), you might be overwhelmed with all of the machinery—but what we can do is recognize repeating machinery, or similar machinery that are essentially doing the same thing. We use process of elimination to narrow down the mass lot of machinery by eliminating all of the machines and or robots that do the same things, so that now we have in front of us only the disparate machinery all standing in stark contrast to each another. This allows us to filter and process the information quicker and easier. PE3 may sound similar to PE2, but they are not the same. PE2 is used more consistently in the 21^{st} Method, and has almost constant application with regard to filtering through material in an expedited fashion; segmentation is a very important word in this 21^{st} Method, and PE2 is constantly filtering with an eye to segmenting data, whether it is segmenting data in the textbook, or segmenting data on the computer that is related to touch of a button access to data/information (TBI). This is in contrast to PE3 which is generally seeking to greatly shrink data/information (where applicable). Segment the data (PE2), shrink the data (PE3), ensure that the data is complete (PE1), attenuate the data/simplify (A), contrast the data (C1-C3), process the data through flowing system templates (FSS), never stop moving with an understanding given to the notion of FRESH EYES (E) and repeat when necessary for clarity in comprehension (R). PE3 is a matter of cutting information down to size, where PE2 is a matter of shuffling segmented data around to ensure that no time is wasted reading through material that is not currently pertinent. All three forms of the PROCESS OF ELIMINATION STRUCTURE are constantly segmenting/restructuring the information, shrinking the information and making sure the information is complete.

The next LEARNING STRUCTURE is the REVERSE ENGINEER/NON-LINEAR STRUCTURE. The reverse engineer part of this learning structure should be thought of as something like, “training wheels”, until the NON-LINEAR LEARNING STRUCTURE can be fully utilized, which is usually after the user has applied the reverse aspect. In other words, the reverse aspect of attacking learning material starts first, then once the user can work well in reverse, then the non-linear path would be attempted at that point, in many cases. The “training wheels” are there to help oneself begin to acclimate to this notion of totally circumventing the conventional method of moving from page 1 to page 2, chapter 1 to chapter 2 and so forth. The REVERSE ENGINEER STRUCTURE throws the user into the generally uncommon territory of starting from the back of the book and moving to the front. This forces the student to immediately start acclimating to the Method of Learning Based on 21st Century Technology. Eventually, the student will be able to use this method in a non-linear format, applying it where and when they choose. In some cases, the user may prefer to simply use the REVERSE ENGINEER STRUCTURE as opposed to the NON-LINEAR STRUCTURE—but these two LEARNING STRUCTURES are grouped together because they both flip the same metaphorical switch. It is the switch that says we have just switched from the conventional meander approach to the non-conventional active attack plan approach. The REVERSE ENGINEER STRUCTURE is referred to as training wheels because in reverse, the path is always clear—it is simply moving in a linear fashion but backwards; whereas, the NON-LINEAR STRUCTURE is more chaotic, yet they are using the exact same formula (embodiment) depicted in FIGS. 1-6 in the Diagrams section of the patent.

The ATTENUATION STRUCTURE can most succinctly be understood in a very simple example. The example would be to simply take a complex sounding word and find a synonym for that word that sounds common and ordinary. This would be something like the word, “bifurcation”, and then attenuating it to mean, a “divide”. We can do this attenuating with all forms of study material, though. This example notion of taking complex sounding words and looking for their most basic synonym is simply the easiest and most succinct way to define the ATTENUATION STRUCTURE—just as it was in giving the example of reading a long binary number for PE2. The application of both of these LEARNING STRUCTURES goes beyond these examples, but the applications will be different depending on the sample learning material that is given. It is a matter of taking the logic that is cited, and seeking to apply it whenever and wherever possible, and this is where the teaching aspect has to come in to some extent as well. When we look at some of the jargon that is out there with relation to computer technology, it is quite striking. This opens the door for a lot of attenuating and a lot of simplifying. The ATTENUATION STRUCTURE is always alive in 21^{st} Method, always seeking to make what appears to be complex on the surface, into something more basic and ordinary, and then the other LEARNING STRUCTURES can work all the more effectively from there. Just as the PROCESS OF ELIMINATION STRUCTURE should always be working in the back of the mind, so is true of the ATTENUATION STRUCTURE. The ATTENUATION STRUCTURE will play a large role in leading the user to the realization that there are only so many fundamental forms, forces, attributes, systems, etc., and this is one of the goals in reaching mastery of the 21^{st} Method.

The seventh LEARNING STRUCTURE of the 21^{st} Method might seem frivolous or even redundant, but it is neither—especially when it is understood within the context of a complete system that is always flowing without any hard angles, and within the context of the synergy that each structure contributes to the greater method as well. This is the LEARNING STRUCTURE known as the NEVER WASTE BRAIN ENERGY STRUCTURE. We see so much brain energy wasted in the current system of learning. How many times does a student get stuck and spin their wheels in the mud for 45 minutes? Those precious 45 minutes will never be had again. And again with regard to context, with the 21^{st} Method being non-linear, the door is always open to move to other areas of the study material at will. In many cases when the learner is stuck on something specific in the material, then when they step away from that material and then later come back (after briefly diverting their attention), when the student returns, the material is crystal clear right away. This is referred to as FRESH EYES in the 21st Method. This can be accomplished by moving to other parts (non-linear) of the study material, so that the flow of learning remains intact.

In computer software programming, we are given a number of what are termed, PROGRAMMING STRUCTURES—these include PROGRAMMING STRUCTURES such as the CASE STRUCTURE, the “IF, THEN” STATEMENT STRUCTURE, the “IF, THEN, ELSE” STATEMENT STRUCTURE, LOOP STRUCTURES (FOR LOOPS/WHILE LOOPS) and so on. In contrast, we want to think about the seven LEARNING STRUCTURES of the 21^{st} Method as being used in a similar way: to act on data (with pure logic) with extreme efficiency and effectiveness. In the case of the programming language, the optimal exercising of these PROGRAMMING STRUCTURES can lead to a magnificent computer program. When using the seven LEARNING STRUCTURES of the 21^{st} Method (synergistically) in conjunction with access to touch of a button data and/or information, we receive a universal method to learn and act on technical-data (of all kinds) with extreme speed and effectiveness, and we also receive greater mental clarity in general as well as increased creative skills. In this way, the 21^{st} Method is not only a learning tool, but it is a thinking tool as well. Because it should be clear, the PROGRAMMING STRUCTURES used in computer programming are there to process data/input at maximum speed and efficiency, there are no frills, just pure data. In the 21^{st} Method, we are for all intents and purposes getting rid of the narrative in most textbooks—which will leave us with pure data points in like manner, and this in turn sets us up to move through the learning process in a way that is similar to a computer moving through software code. How do we do this? We do this with the proper application of the seven LEARNING STRUCTURES of the 21^{st} Method in conjunction with our access to touch of a button retrieval of information/data. So in turn, we are using these seven LEARNING STRUCTURES to compute data points, in effect, turning our minds into computers. But what is more, we become more than computers—because in the 21^{st} Method, we are sure to focus on that one area of the organic brain that we possess that will always be superior to electronic computers—electronic computers based on binary digits and switches —: that is, the creative part of our brain that allows us to create something like a computer to begin with. The 21^{st} Method also focuses on STRUCTURES that are more computer-like, such as the PROCESS OF ELIMINATION STRUCTURE. While a computer can use process of elimination more quickly and efficiently than we can, we can use it with a great deal of effectiveness as well. And with the 21^{st} Method being deeply intertwined with touch of a button access to data, that same touch of a button access can be used as a tool to maximize our process of elimination skills as well.

A computer must break down information into a rudimentary form, so that it is then able to work at the incredible speed and efficiency that it does. In the 21^{st} Method, we are doing something similar to this. Obviously, the human brain is not breaking down information into 0's and l's, but, we certainly can break it down to an extent (components/data points/characteristics/flow/etc.) And in like manner, once it is broken down, we can set our minds free to work on the data in a way that makes our CPU (human brain) much more efficient and powerful. We see for example when we use the CONTRAST LEARNING STRUCTURE, we essentially end up with columns of raw data in bullet point form—we have broken the data down to a degree (it is no longer in a narrative form). And in the example of the CONTRAST STRUCTURE, we are putting our brains on the right footing—because properly focusing our minds on subject matter from a contrast/compare perspective, initiates access to the parts of the brain that optimize our learning abilities.

Students many times struggle because they lack context—to know and understand (through training) that no matter what they are dealing with, no matter how new it seems, it can always be defined as a flowing system, serves a major purpose.

We start with the REVERSE ENGINEER/NON-LINEAR STRUCTURE, this immediately tosses us out of the conventional system of slow-moving learning that generally renders the learner passive. In being thrown into the material, either at the back of the book, or at some random point in the material (NON-LINEAR STRUCTURE), we become active doers, and we learn best in these cases (many do).

Repetition is one of the most widely used mechanisms for strengthening neural pathways in the brain with relation to the learning process. The constant repetition of procedures will eventually coincide with changes in brain tissue. In the 21st Method, we want to get the most out of brain mechanisms such as these. Repetition allows us to initially increase our focus by eliminating (process of elimination) data that is irrelevant to our objective—and then from that point, brain activity moves into LTP (long term potentiation) as a means of taking our memory and focus to the next level.

We see that repetition can be especially effective when used intermittently—this is due to the combination of repetition's intrinsic effectiveness in conjunction with the concept of looking at material with FRESH EYES. The concept of FRESH EYES together with the REPETITION STRUCTURE also has implications with regard to the NEVER WASTE BRAIN ENERGY STRUCTURE, which in this particular context would inform us to use repetition, but to use it intermittently so that we are not wasting any time, and then the payoff being that by not wasting time (NEVER WASTE BRAIN ENERGY STRUCTURE), we will see in many cases as we look at the material again with fresh eyes, everything becomes clear at that point, anyway. This is the kind of synergy and efficiency that we would be striving to create while using all of the LEARNING STRUCTURES in the 21st Method.

We see another learning dynamic that occurs when we sometimes use the learning structure of contrast. This is where we take two items that are foreign to us, and by the simple process of contrasting them together, they become understood. These are the kinds of dynamics that are interwoven within the learning process of the 21^{st} Method (CONTRAST STRUCTURE).

The FLOWING SYSTEM STRUCTURE identifies all elements of a particular flowing system (all things can be defined as flowing systems), and then identifies the flow that occurs through these elements to animate the system. This allows us to immediately begin building a flowing system (whether mentally noted or physically typed/written) whenever we are presented with new material. We take this up a level and identify all distinct flowing systems in the material, and then identify all possible dynamics that occur between these flowing systems—and with their environments (environments are flowing systems as well). This is now a reality that we can do this thanks to TBI and the 21^{st} Method. Interestingly enough, this process alone can be enough to learn anything and everything—because everything in this life and in this world can be fully and completely understood through the construct of flowing systems and the dynamics that take place between them (flowing systems). In other words, if we just jumped into the learning material with this one thought that all things are flowing systems and to catalog all components and their flow, and then to catalog the dynamics that take place between these flowing systems, in conjunction with touch of a button access to information/data, if we used no other parts of the 21^{st} Method, this would still give us the base formula to know everything that there is to know.

This process of utilizing the FLOWING SYSTEM STRUCTURE as noted above can define very simple concepts as well as very complex concepts. If we had no understanding of how the game of basketball was played for example, we could assign each player as a flowing system—and as such, we would need to catalog all pertinent player attributes and actions (define the template of a basketball player, label his/her components and flow), then once all flowing systems have been cataloged (including the environment), then all dynamics that occur between all flowing systems would need to be cataloged and examined. In a more complex example, we could identify all atoms as individual flowing systems (periodic table). We would then catalog all of their individual components/actions (atoms), and then we would want to identify all possible interactions between these many distinct flowing systems (different reactions between different kinds of atoms), and catalog these interactions as well as examples of the dynamics that take place between distinct flowing systems. We now have the online resources to move through and master material like this with extreme speed and efficiency.

Once you have mastered a flowing system, it becomes easier to think in terms of flowing systems, and to generally apply the logic of flowing systems in all things. We find that even inanimate objects are constantly flowing/moving in a system, at the atomic level. It is in this understanding that we see the fact that nothing exists that cannot be understood through the flowing system structure. The constant thought/context that everything is a flowing system is a LEARNING STRUCTURE (FLOWING SYSTEM STRUCTURE) of 21^{st} Method.

The FLOWING SYSTEM STRUCTURE will always help to guide the process of investigation, and it will help to provide the necessary questions that help to steer the learning process. This is why it is listed as a supporting structure for process of elimination below. When we are talking about the fact that the FLOWING SYSTEM STRUCTURE, “will always help to guide the process of investigation”, we can see that once we identify the flowing system that we are working with, we would then be asking questions such as, “what are the components of the flowing system, how do these components singularly function, how do they function as it relates to interacting with other components in the system, how do they function with regard to other pertinent flowing systems, what type of flow (blood/electricity/wind/water/etc.) is flowing within the system, what direction does it flow and how does that flow animate said system, etc. And of course as was mentioned earlier, the process of investigation would be constantly moving either down or up the ladder in terms of flowing systems within flowing systems—systems within systems, flow within flow and so forth.

The PROCESS OF ELIMINATION STRUCTURE is an important structure within the 21st Method. Process of elimination both hones this technique and also helps to keep it efficient and orderly.

Reverse and non-linear reading forces the questions of, “what is?” (WI) or “how?” (H), and process of elimination forces the question, “did I?” Of course, the “what is?” and “how?”, questions are essentially involuntary brain responses, but the “did I?” questions require some conscious formulation on the user's part—though they are still mostly a small group of circumstantial questions that will become evident over time with use of the 21^{st} Method. All of this is based on a complete and perfect math that follows the same underlying logic of computer programming structures and computer hardware logic.

Everything is an equation—and, everything is a flowing system. The equation is the math behind the flowing system, and the flowing system is the product of the math. The equation for this learning system is being given to you in all of these learning structures. We are breaking down and organizing information in a way that is similar to the way a computer breaks down and organizes information; so that once the data has been properly broken down and correctly organized, it can be processed by the human mind in a way that mimics the style of an electronics computer.

The information in this patent submission is ideally giving the examiner the ability to use the method and observe its functionality. We need to look at this from two sides, though. The one side is that all of the information in this patent does in fact provide that information, but also the other side of the patent that makes it clear that some training (over time) is necessary to perfect the use of this patent. With that said, I want to briefly summarize what should be absolutely evident from the first side of what was mentioned. We understand that we are first circumventing the conventional method of approaching study/learning material by utilizing either a reverse style (back to front) approach or with a non-linear approach that allows us to move as we please through the material (REVERSE ENGINEER/NON-LINEAR STRUCTURES). With that said, we can now begin moving through our study material realizing that only one of two questions will be entering our mind as we do move through our study material for the first time: What is? or How? Again, we want to harken back to the success of computer technology in recognizing that it is through the ability of breaking all things down into either binary or into other very basic mathematical standards that we see the success of computer technology becomes possible, and the 21^{st} Method is no different, with those two questions mentioned above being yet another example of how we are doing the exact same thing that a computer does. When we read, either we say to ourselves, “What is x?” or “How does x?”—of course questions of quantity may arise but they have no relevance. When we identify that we are asking the question “What is?”, we move to the FLOWING SYSTEM STRUCTURE, because everything (is) a flowing system. Therefore, we begin the process for the FSS, which includes either physically drawing a diagram, pulling a diagram from the Internet, or simply envisioning this diagram in our minds—and from there, we know that it is a matter of labeling the components of the system (SYSTEM), which is simply a compilation of components—once again we are doing what a computer does, then we identify the FLOW that is interacting with the components (gas, liquid, numbers, etc.) We use the PE1-PE3 Structures to organize our data properly and ensure that nothing is being missed in our data. If the CONTRAST STRUCTURE is available, then we are taking the characteristics from each contrasting system and we are enumerating them in bullet point columns (whether physical or mental), we are using TBI to gather the information on each bullet point, then we are comparing the differences and similarities between those entities for the purpose of initiating a brain mechanism that is one of the most important in the human mind as it relates to intelligence. PE1-PE3 continue to play a role in making sure that the contrasting data/information is also being organized correctly (when using the CONTRAST STRUCTURE is available), and we are also utilizing the ATTENUATION STRUCTURE on all of our FSS information and C1-C3 information in conjunction with PE1-PE3 to further break the information down into its most rudimentary form (for comprehension) and organization. We use the REPETITION STRUCTURE throughout all of this just as we would in the conventional system (as needed) and we always keep in mind the properties of the NEVER WASTE BRAIN ENERGY STRUCTURE for the purpose of keeping the process flowing at all times, and reminding us the advantages of moving away from the current material in favor for other related material, only to return to the current material and in doing so benefitting from FRESH EYES. While this information provides the shell for utilizing the 21^{st} Method, other material is included in this patent to explain both why this works but also that some of what is being required with regard to carrying out the 21^{st} Method takes some pre-requisite training to some extent so that it is completely clear. One example of this would be in using something like PE2. PE2 is an invaluable tool for researchers, but it takes time to truly be able to use PE2 in the most optimal of ways, and it takes training. This was written here to help to differentiate the one side of understanding the 21^{st} Method from a rudimentary angle, and then understanding that there is the other side of the 21^{st} Method that (for many) will take time to actually learn and be trained in order for it to be used to its full extent. While the flowchart diagrams and this preceding information would be enough to demonstrate the 21^{st} Method from a rudimentary level—the rest of the writing in the patent is there to explain the more complex aspects of the 21^{st} Method.

Here is a checklist of the structures used in the 21st Method.
The Reverse Engineer/Non-Linear Structure: Reading Starts From The Last Sentence Of The Last Page (Reverse) Or From Randomized Locations (Non-Linear). The Most Effective And Efficient Path. Encourages Active Rather Than Passive.
Flowing System Structure: Sharpens Context And Defines All “Things” No matter How Foreign The Material Is/Secondary Structure For Steering The Learning Technique.
Process of Elimination Structure: Keeps The Flow Of Learning Structured And Ensures That No Material Can Be Accidentally Missed/Primary Structure For Steering The Learning Technique.
Contrast Structure: Learning Facilitator/Primary Idea Facilitator.
Repetition Structure: Learning Facilitator/Secondary Idea Facilitator.
Never Waste Brain Energy Structure: Efficiency. Repetition And Fresh Eyes. Always Move To Other Relevant Material If A Stall Has Occurred In The Learning Process.
Attenuation Structure: Strip All Data Down To Its Base Form.

When you become a master of this technique, you will notice that everything comes together into one mechanism, a synergistic template. The 21st Method eventually becomes a template that you will superimpose over any and all learning material. When this synergistic template is then married to our ability to pull data at the touch of a button, we will see its full potential.

In further explaining the structure, “Never Waste Brain Energy”, this simply means that if you are not making progress in a particular area, just move to another relevant area. We are already circumventing the linear learning process, so it will not hurt to move to a section that holds relevance outside of what is currently being focused on. In fact, in some cases this also sheds light on what you were trying to understand that you moved from initially. I generally tell myself that as long as what I am working on has to be covered at some point, then it is never a waste of time. Many people will get stuck on something and burn brain energy for 45 minutes that produces absolutely nothing, or they simply just walk away and use that good brain energy on something worthless. This is not only a waste of time that could have been spent on something relevant, but it can sour you on the entire subject. We could see this as something like a jeep that is stuck in the mud—how long will the driver continue to press the gas over and over without moving, to the extent of causing damage to the vehicle? We must be able to recognize these instances in our learning so that we can properly respond.

Below are two brief examples of using the 21^{st} Method.

We will start at the bottom of the Wikipedia page for, “computer”.

“Artificial Intelligence”

“A computer will solve problems in exactly the way it is programmed to, without regard to efficiency, alternative solutions, possible shortcuts, or possible errors in the code. Computer programs that learn and adapt are part of the emerging field of artificial intelligence and machine learning. Artificial intelligence based products generally fall into two major categories: rule based systems and pattern recognition systems. Rule based systems attempt to represent the rules used by human experts and tend to be expensive to develop. Pattern based systems use data about a problem to generate conclusions. Examples of pattern based systems include voice recognition, font recognition, translation and the emerging field of on-line marketing.”

Right away we are dealing with some very interesting material. We see that we are under the heading of “Artificial intelligence”, and we have examples of “pattern based systems”. We have read two sentences and a heading and already we know that artificial intelligence is using something called a pattern based system, and we already have four named examples of pattern based systems. In the next sentence (working from the absolute bottom), we have another type of system in artificial intelligence called, “rule based systems”, and we know that they “attempt to represent the rules used by human experts”. This is an incredible amount of information that we have from reading three sentences. Also, it sets up an opportunity for using the contrast structure between the pattern and rule based systems. The questions that arise from contrasting these two systems together will undoubtedly lead us to many answers (and maybe some new ideas of our own).

We want to keep in mind the importance of how the learning structures in the 21st Method run into each other (or link together as the learning process moves forward), and how this serves as a guide in providing the path forward in many cases. In listing all of our bullet point characteristics of contrast, we now have much of our information needed to feed the FLOWING SYSTEM STRUCTURE (e.g. contrast structure running into the flowing system structure). This is because the characteristics that are garnered from the process of contrasting two or more items together will also have relation to the components of the examples being looked at, and of course the components that comprise each item will be necessary in filling in our FSS diagram. If for example we just wanted to start with the FLOWING SYSTEM STRUCTURE, we would have immediate guidance as well. We would know to look at the material as a whole, identify each distinct flowing system, and then identify the dynamics that take place between those flowing systems. Even if we do not comprehend what it is that we are filling into the flowing system template, we can use the other learning structures in conjunction with TBI to then flesh out what has been filled in after it has in fact been filled in. All the while PROCESS OF ELIMINATION STRUCTURE is keeping the process orderly and ensuring that no points are missed. The important point here though is to see how all of the structures are linking together—where one leaves off, the other then starts, etc. They are constantly handing off to each other.

If we look at the beginning of the Wikipedia entry for, “Computer”, it states: “A computer is a device that can be instructed to carry out sequences of arithmetic or logical operations automatically via computer programming. Modern computers have the ability to follow generalized sets of operations, called programs. These programs enable computers to perform an extremely wide range of tasks. A “complete” computer including the hardware, the operating system (main software), and peripheral equipment required and used for “full” operation can be referred to as a computer system. This term may as well be used for a group of computers that are connected and work together, in particular a computer network or computer cluster.”

“A “complete” computer including the hardware, the operating system (main software), and peripheral equipment required and used for “full” operation can be referred to as a computer system.” This information will be covered in reverse, and with the exerting of about 1% of the energy that would have otherwise been required. This is also a dynamic that occurs within the 21st Method—there is much less effort required to cover introductory material when using the REVERSE ENGINEER/NON-LINEAR STRUCTURE. We are establishing a framework, but again, understand that this should be somewhat tailored to your own way of working. For example, when I cited the paragraph on the previous page, notice that I did not simply ignore the heading, Artificial intelligence, due to it being before the very last sentence of the last paragraph. This is one of the common sense aspects of the 21st Method, and it takes time to develop your own niche for moving in a non-linear fashion and/or reverse fashion while using all of the tools and processes in the 21st Method. The freedom that you gain from the 21st Method—in contrast to the conventional method—is very nice.

In briefly turning back to the structure of flowing systems, this structure has immense power when combined with the touch of a button access to data and information that we now have. In the past, getting information was dictated to you by big thick textbooks (each containing only fragments of the subject at large). We can now pull up one web page that contains the information in all of those collective textbooks. The ability to do this opens the door for the FLOWING SYSTEM STRUCTURE in a way like never before. In addition, the attenuation structure with the process of elimination structure can be very helpful in getting the most out of the FLOWING SYSTEM STRUCTURE. Process of elimination is very important in ensuring that all singular aspects of each flowing system have been cataloged, and that all dynamics between these flowing systems have also been cataloged.

We start to see how the PROCESS OF ELIMINATION STRUCTURE, FLOWING SYSTEM STRUCTURE and ATTENUATION STRUCTURE all come together. It turns an aspect of our brains into a machine. We retain all of who and what we are—we simply gain the skill of a machine, just as we would learn and incorporate any other skill.

We can be confident that everything that we perceive as complex, can be broken down into simpler forms. The most basic example (ATTENUATION STRUCTURE) of this fact is in the use of words. How many words sound extremely complex, only to be synonymous with other words that are very common and basic. This is another example of this attenuation concept, and it can be applied in all subjects and in all things.

For the second example we will use the Wikipedia entry for the Human Brain.

“Comparative Anatomy”

“As a hominid brain, the human brain is substantially enlarged even in comparison to the brain of a typical monkey. The sequence of human evolution from Australopithecus (four million years ago) to Homo sapiens (modern humans) was marked by a steady increase in brain size.[255][256] As brain size increased, this altered the size and shape of the skull,[257] from about 600 cm3 in Homo habilis to an average of about 1520 cm3 in Homo neanderthalensis.[258] Differences in DNA, gene expression, and gene—environment interactions help explain the differences between the function of the human brain and other primates.”

Let's look at one possibility for using the REPETITION STRUCTURE with regard to the above entry. While the idea of using repetition is a very straightforward one, I want to be able to give examples of each of the 7 LEARNING STRUCTURES. The 21^{st} Method is like getting a new car—it takes time to get the feel for the car, and then in time, you become acclimated to the car. In this case of repetition, it is more about the reader deciding when to use this structure as opposed to one of the other structures, and it is also about understanding the fact that we will be using repetition in conjunction with our other LEARNING STRUCTURES (structures running into each other—just as electronic functions run into each other within the actual silicon).

If we read that last sentence again, “Differences in DNA, gene expression, and gene—environment interactions help explain the differences between the function of the human brain and other primates.”, we can assume an example where an individual reads this and is confident in their understanding of DNA and gene expression, but having difficulty in understanding gene-environment interactions. In this case, we would also want to keep in mind the structure to not waste brain energy. When this structure is properly combined with the repetition structure, it keeps things running much more smoothly.

In combining the REPETITION STRUCTURE with the structure of not wasting brain energy, we could keep gene-environment interaction to the side, return to our main topic (human brain), and then return to gene-environment interaction intermittently as a means of repetition. As was mentioned, we should move to another relevant area of study as opposed to wasting brain energy. When we are moving back to front, we are already circumventing the standard process, so moving to another relevant area should be up to the reader to decide on what that area will be, as has been mentioned. The main thing that we are aiming to avoid here is the spinning of wheels. Many times, we have issues with letting go of something we don't understand (for the time), and allowing ourselves to relax and take in other material from a different area of the overall subject of study.

One of the main benefits in using the REPETITION STRUCTURE with the NEVER WASTE BRAIN ENERGY STRUCTURE is in the fact that we have all seen the benefits of stepping away from something, then coming back to it fresh—in many cases, we immediately understand the material now as we look at it again with FRESH EYES.

Human Brain Entry Cont'd

“Comparative Anatomy”

“As a hominid brain, the human brain is substantially enlarged even in comparison to the brain of a typical monkey. The sequence of human evolution from Australopithecus (four million years ago) to Homo sapiens (modern humans) was marked by a steady increase in brain size.[255][256] As brain size increased, this altered the size and shape of the skull,[257] from about 600 cm3 in Homo habilis to an average of about 1520 cm3 in Homo neanderthalensis.[258] Differences in DNA, gene expression, and gene—environment interactions help explain the differences between the function of the human brain and other primates.”

Once again in this example we are starting with not only great information, but also an immediate opportunity to use our structure of contrast again. The last sentence at the end of the entry reads, “Differences in DNA, gene expression, and gene-environment interactions help explain the differences between the function of the human brain and other primates.” Let's look at the second part of the sentence, “help explain the differences between the function of the human brain and other primates.” This sets up a contrast mechanism between the functions of the human brain and the functions of the primate brain. Looking at these contrasting factors between humans and primates as it relates to DNA, gene expression and gene-environment interactions, will undoubtedly give us much of the core information that we seek. And from there, we can use the other structures in the 21^{st} Method to guide us in refining and completing the process of assimilating this important information.

We would want to make two basic columns—one for humans and one for the selected primate, and then make three pages like this. One should be labeled, “DNA”, the next should be labeled, “gene expression”, and the third page should be labeled, “gene-environment interactions”. The process of contrasting all of this data in conjunction with other relevant structures in the 21^{st} Method and touch of a button access to information/data, will steer a very effective learning process with regard to this material. Before broadband internet, and before many trusted institutions began making all of their data accessible online, entire books would need to be read before you could even get started with a process like this. This is no longer true, and this opens the opportunity for great advancements in education.

When we move in either reverse or in a non-linear fashion, the writer (of the textbook or electronic document) is no longer leading us. By moving in reverse, the onus is now on the reader to process the information in a more involving manner than would have otherwise been the case. It is about creating an entry point into the data that is outside of the linear stream—and from that entry point, we begin to implement all of the appropriate LEARNING STRUCTURES at the proper time.

The 21^{st} Method calls for the user's discretion in deciding when is enough in terms of how much of an understanding is necessary with regard to secondary and tertiary information (related to the main topic of study). In many cases, simply being able to cite definitions is enough—assuming that the definition can be well explained. All of this requires some discretion, and will be worked out the more that the 21^{st} Method is used. The full study of this material related to the human brain would undoubtedly yield an enormous amount of data. I would definitely recommend starting with much simpler information in utilizing the 21^{st} Method.

1. A method for training the human brain to learn source material in such a way that information can be processed with extreme speed, efficacy and efficiency in conjunction with touch of a button access to information/data, comprising: three CONTRAST STRUCTURES, a FLOWING SYSTEM STRUCTURE, an ATTENUATION STRUCTURE, a REPETITION STRUCTURE, a NEVER WASTE BRAIN ENERGY STRUCTURE, three PROCESS OF ELIMINATION STRUCTURES and a REVERSE ENGINEER STRUCTURE/NON-LINEAR STRUCTURE, and said STRUCTURES are used as operators between the human mind and the study information/data itself in a framework designed to maximize synergy in learning and brain power, which has only now been made possible with the ability to pull any information/data at the touch of a button.

2. The method in claim 1 wherein CONTRAST STRUCTURE number one (C1) is used to take two similar items within the source learning material that are within relative proximity to each other so as to list their attributes side by side for the purpose of transforming them into a list of individual properties for optimal processing within the 21^{st} Method and to initiate a process of study and research that activates brain mechanisms that are most optimal in learning effectiveness, speed and efficiency, which also maximize clarity and focus.

3. The method in claim 1 wherein CONTRAST STRUCTURE number two (C2) is used to take one item from the source learning material and extrapolate a second item so as to list their attributes side by side for the purpose of transforming them into a list of individual properties for optimal processing within the 21^{st} Method and to initiate a process of study and research that activates brain mechanisms that are most optimal in learning effectiveness, speed and efficiency, which also maximize clarity and focus.

4. The method in claim 1 wherein CONTRAST STRUCTURE number three (C3) is used to take one item within the source learning material and then to seek out one's own knowledge to insert an appropriate second item so as to list their attributes side by side for the purpose of transforming them into a list of individual properties for optimal processing within the 21^{st} Method and to initiate a process of study and research that activates brain mechanisms that are most optimal in learning effectiveness, speed and efficiency, which also maximize clarity and focus.

5. The method in claim 1 wherein the FLOWING SYSTEM STRUCTURE (FSS) is used to take any item or any “thing” within the source learning material and clarify its meaning by the use of applying a universal template known as the FLOWING SYSTEM STRUCTURE that is able to define any tangible/intangible “thing” by means of creating a labeled template of components that are the system along with arrows that are the flow which illuminate the understood fact that all things in existence, both tangible and intangible, can be understood through these flowing systems and the dynamics that take place between them.

6. The method in claim 1 wherein the REVERSE ENGINEER/NON-LINEAR STRUCTURE (RES/NLS) is used to enter into the source learning material at the end of the material rather than the beginning, or to enter the study material at a random juncture (NON-LINEAR) in the study material as a method for circumventing conventional techniques for the purpose of initiating all 21^{st} Method LEARNING STRUCTURES, and starting the process of breaking down learning material from narrative form to data point form.

7. The method in claim 1 wherein PROCESS OF ELIMINATION STRUCTURE number one (PE1) is used to ensure all components of any and all flowing systems have been accounted for and that all information pertaining to flow has been accounted for as well as ensuring that all other relevant information is accounted for as a result of the fact that all study information must at some point be passed through the FLOWING SYSTEM STRUCTURE, and there is nothing that exists outside of these flowing system structures, which ensures that no gaps can be had.

8. The method in claim 1 wherein PROCESS OF ELIMINATION STRUCTURE number two (PE2) is used to move through both the source learning material and learning material garnered via touch of a button access to information/data in a way that allows for expedited mental processing by using the elimination of impertinent information technique explained in this patent.

9. The method in claim 1 wherein PROCESS OF ELIMINATION STRUCTURE number three (PE3) is used to ascertain information that is either repeating information or information that is essentially the same for the purpose of shrinking the data pool, which in turn allows for more efficient and faster comprehension whether in the source material or via touch of a button access information for the purpose of faster, more organized and more efficient processing within the 21^{st} Method.

10. The method in claim 1 wherein the REPETITION STRUCTURE (R) is used to contribute to the process of comprehension as it relates to touch of a button access to information and to the 21^{st} Method by acting as a complement to the FLOWING SYSTEM STRUCTURE, the CONTRAST STRUCTURES, the PROCESS OF ELIMINATION STRUCTURES, the ATTENUATION STRUCTURE and the REVERSE ENGINEER/NON-LINEAR STRUCTURE.

11. The method in claim 1 wherein the ATTENUATION STRUCTURE (A) is used to simplify all information gathered via touch of a button access information as well as in the source material for the purpose of maximizing the effectiveness of the FLOWING SYSTEM STRUCTURE, the CONTRAST STRUCTURES, the PROCESS OF ELIMINATION STRUCTURES, the REVERSE ENGINEER/NON-LINEAR STRUCTURE and the REPETITION STRUCTURE by always breaking information down to its most rudimentary form for the purpose of maximizing speed and comprehension.

12. The method in claim 1 wherein the NEVER WASTE BRAIN ENERGY STRUCTURE (E) is used in cases where a snag in the flow of learning has occurred, so that rather than wasting time trying to force comprehension, the reader will instead move to a different section in the learning material (NON-LINEAR) for the purpose of upholding the goal of a permanent learning flow, and to also assist in triggering what are termed fresh eyes, or the learning dynamic that is observed when the student steps away from the material for a brief period, only to immediately comprehend the material when stepping back in front of the material some time later.
